(19) United States
(12) Patent Application Publication
(10) Pub. No.: US 2011/0096392 A1
(43) Pub. Date: Apr. 28, 2011

(54) Multifunctional Microscopes

(76) Inventor: Ming Hua Xiang, Manassas, VA (US)

(21) Appl. No.: 12/607,717

(22) Filed: Oct. 28, 2009

(51) Int. Cl. G02B 21/00; G02B 21/06

(52) U.S. Cl. 359/381; 359/385

(57) ABSTRACT

A multifunctional microscope with a plurality of light sources made of various materials is provided. Plural light sources enable solid objects and slide specimen observations possible at a single microscope. Cordless power supply is also equipped to give the microscope portability of providing convenient field study. Further to the portability, low manufacturing cost makes the microscope suitable for any budgets, even toys for children and young adults learning science at early age. The plural light sources with adjustable angles provide further research capability and more fun in learning through observation.

### TECHNICAL FIELD

The present invention is related to microscopes used for research, field study, and fun. Particularly, the present invention relates to microscopes with a plurality of light sources that can be utilized for lab researches, field observation, or even for fun as toys.

### BACKGROUND

There are two distinct types of light microscopes: compound and stereo microscopes. Although all light microscopes are based on the same optical theoretical principles and share the same basic components, compound microscopes and stereo microscopes serve different purposes and have different functions. For example, the image produced by a traditional compound microscope is two dimensional while the image produced by a stereo microscope is three dimensional. The former is often used to view objects at cellular level; the latter is used for dissection to view at the larger specimen such as a tissue.

In order to provide a high resolution two dimensional image of microscopic objects, the specimens must be sliced very thin and placed onto a glass slide of a compound microscope, and visible light is passed through the specimen that is then magnified by objectives and eyepiece for human eye viewing; the thinner the specimen, the sharper the image.

However, large three dimensional objects such as a tissue or a whole organism cannot be viewed by using this type of conventional microscope. This is because with the nature of visible light a conventional compound microscope can only focus on a specific focal plane of the specimen, and any other part of the specimen not within this focal plane is out of focus, making three dimensional images lost in the blurriness.

There are two types of stereo microscopes. One is Greenough-type stereo microscope which uses twin body tubes that are inclined at a small angle to produce the left and right images. The other is Common Main Objective or CMO-type stereo microscope which uses the refracting action of a single objective shared by both eyepieces.

While a stereo microscope can use both episcopic and diascopic illuminations, it often uses the former type of illumination. Such utilization allows a stereo microscope to be able to examine a large and thick specimen which a conventional compound microscope is unable to handle. These qualities of a stereo microscope make it become a preferred tool in medical and biological research to study a whole organism such as a fruit fly, or to examine the surfaces of solid specimens or to observe issues for dissection and surgery, as well as other industrial applications for a close look of micro objects.

A major drawback for a stereo microscope is due to a well-known fact that chromatic aberrations cause wavelength-dependent artifacts that occur because different refractive index of different lenses to refract different length of lights. As a result, distorted images of specimens often appear in stereo microscopes, particularly in the Greenough-type microscopes because the images generated by the left and right body tubes with inclined angles relative to the specimen plane.

However, key qualities of stereo microscopes, such as three dimensional observation, perception of depth and contrast, cannot be replaced by compound microscopes. These functions are essential to understand and interpret specimen structure. In addition, stereo microscopes are more desirable when observing a living specimen that is sensitive to light damages and requires greater working space to be manipulated.

When observation on both the specimens furnished by slides and solid objects are desired, two types of microscope are required to finish the job. Switching microscopes can be inconvenient, particularly, for field studies. It is inconvenient to carry two types of microscope for field studies and the lack of power source in the field needs to be taken into consideration as well.

Some efforts have been made by taking advantages of both stereo and compound microscopes by designing a hybrid that combines a stereo and a compound microscope. However, this hybrid design is highly complex and sophisticated. More importantly, this system is much more expensive. Most people who need a hybrid microscope are not able to afford this system. Therefore, there is a need for a hybrid microscope that combines the advantageous characteristics of both stereo and compound microscopes into one that has a simple design, easy to use and inexpensive to own.

Hence, a microscope capable of observing both solid objects and specimen in slides is provided by the present invention. A plurality of light sources with different angles and made of different materials are provided for selection. Cordless power supply is also equipped to facilitate convenient field study.

### SUMMARY

Accordingly, it is an object of the present invention to provide a microscope that can magnify both slides specimen and solid objects. A microscope can be used as the traditional biological microscope and the stereo microscope as well.

It is another object of the present invention to provide a microscope with a plurality of light sources that can provide a better light illumination region. Both specimen on slides and solid objects can be observed without switching from one microscope to another.

The plurality of light sources provided by the present invention are adjustable with various angles to fit different observation needs. The plurality of light sources can be formed at various suitable spots at the microscope body arm for better observation of various specimen, slides or solid objects.

Alternatively, the plurality of light sources can both be made with a fixed angle providing ample illumination over and under the observation stage. When various illuminations are needed, a light source with fixed angle can be provided under the observation stage while a different light source with adjustable angle is provided above the observation stage.

Various light components can be selected for different manufacturing purposes. Various light components with different advantages and costs can also be selected to fit different needs and budgets. For example, LED is good for its brightness with low heat and energy saving feature. Fluorescent light is popular and has been used in microscopes for years. Many other types of light components are also options to users.

Further, it is also an object of the present invention to provide a microscope with a plurality of light sources coupled with a special eyepiece so that research can be easily conducted with better results. The zoom power can be up to 400×, 500×, or higher power. Different kind of lens with curvatures can be selected for different needs on different observation.

Furthermore, another object of the present invention is to provide a microscope with high power magnification but much less weight. A microscope with lesser weight can be handled easily and moved from one lab to another. Most of all, the microscope of the present invention is portable. It can be setup at different research locations or field study sites conveniently.

Still further, it is also an object of the present invention to provide a microscope with a cordless power supply so that the microscope is more suitable for field study. The portability of the microscope of the present invention provides research mobility and fun to observers.

In result, the microscope manufacturing cost is much lower due to the magnificent features provided by the present invention. The low cost microscopes according to the present invention can fit in a budget range from research equipments to toys so that children and young adults can start learning science through fun playing with microscopes.

Other objects, advantages and novel features of the present invention will become more apparent from the following detailed description when taken in conjunction with the accompanying drawings.

### BRIEF DESCRIPTION OF THE DRAWINGS

The present invention can be further described in details by combining the following attached drawings with the preferred embodiments:

FIG. 1 illustrates a general schematic diagram of the front view of a preferred embodiment of the present invention;

FIG. 2 illustrates a tilted front view of a preferred embodiment of the present invention;

FIG. 3 illustrates the back view of a preferred embodiment of the present invention;

FIG. 4 illustrates the right side view of a preferred embodiment of the present invention;

FIG. 5 illustrates the left side view of a preferred embodiment of the present invention;

FIG. 6 illustrates the top view of a preferred embodiment of the present invention;

FIG. 7 illustrates the bottom view of a preferred embodiment of the present invention;

FIG. 9 illustrates the schematic view of a two-light source preferred embodiment of the present invention; and

FIG. 10 illustrates the schematic view of another two-light source preferred embodiment of the present invention.

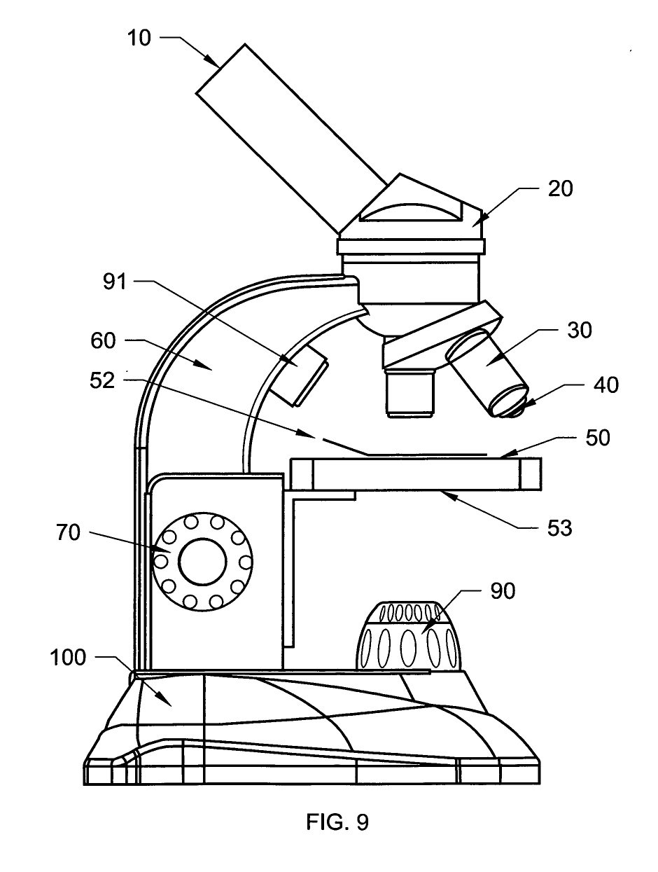

### DETAILED DESCRIPTION OF PREFERRED EMBODIMENTS

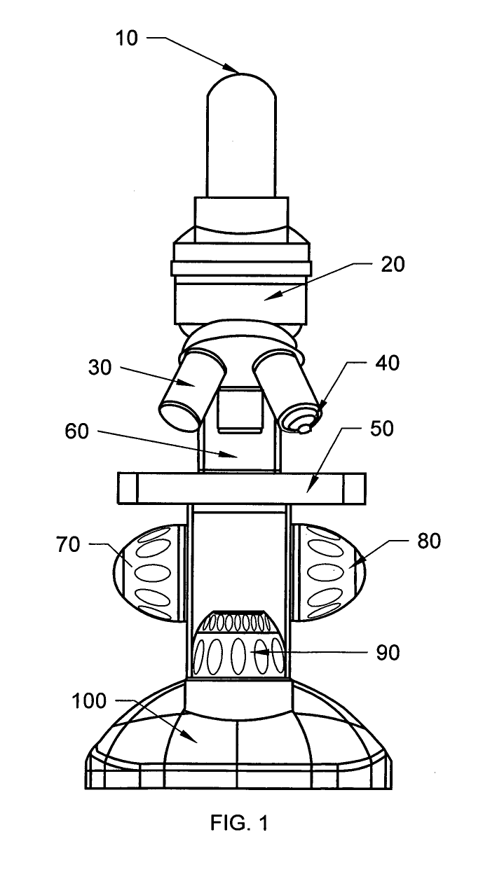

Referring to FIG. 1, a microscope general schematic diagram of the front view of a preferred embodiment of the present invention is illustrated. The microscope has a base 100 at the bottom and an eyepiece 10 containing lens and mirrors at the top of the body tube 20, and two focus adjusting knobs 70, 80 are provided at the sides of a body arm 60. The body arm 60 connects the body tube 20 and the base 100. An observation stage 50 for holding specimen protrudes outwardly from the middle of the body arm 60.

A plurality of objective lenses 40 provided above the observation stage 50 are fixed to a ring-shaped member 30 that contains fitting holes for holding each of the objective lenses 40. An observation stage 50 for observing slides or solid objects is perpendicularly provided at the middle portion of the microscope body arm 60. A right focusing knob 70 and a left focusing knob 80 are provided at the sides of the body arm 60 near the observation stage 50 for the purpose of focus adjustment for various observations.

A light source 90 is provided at the top of the base 100 and under the observation holding stage 50. The light source 90 provides illuminating light for specimen to be observed in slides through a through hole formed at the center of the observation stage 50. An additional light source can be fixed at the inner surface of the body arm 60 above the observation stage 50, with an illumination region right on the observation stage 50 for clear observation on specimen, such as solid objects.

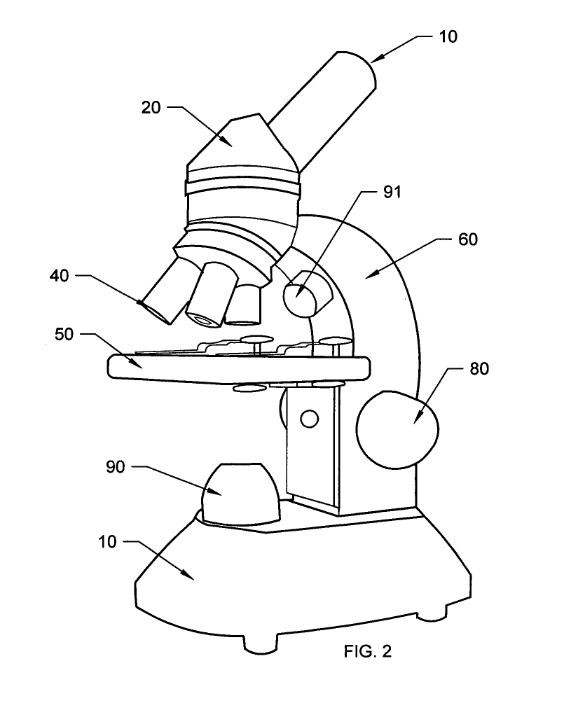

Now referring to FIG. 2, a slightly tilted front view of the preferred embodiment depicted in FIG. 1 is illustrated. In FIG. 2, the eyepiece 10 on tope of the body tube 20 connected to a curved body arm 60 then to the microscope base 100 is clearly illustrated. The additional light source 91 formed at the inner surface of the body arm 60 facing and above the observation stage 50 is also clearly shown in FIG. 2. Both light sources 90 and 91 enable the observation of objects of various forms without switching between different microscopes.

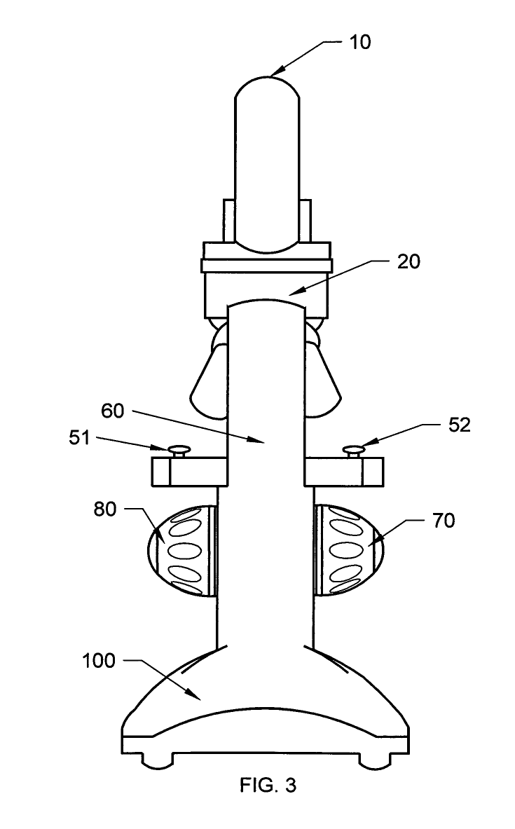

The back view of the preferred embodiment disclosed in FIGS. 1 and 2 is illustrated in FIG. 3. The eyepiece 10 and a curved body arm 10 formed on the microscope base 100 are shown. Two focus adjusting knobs 70 and 80 at the right and left sides of the body arm 60 are formed for easy adjustment while observing objects. Clips 51, 52 for fastening specimen slides are also shown in FIG. 3.

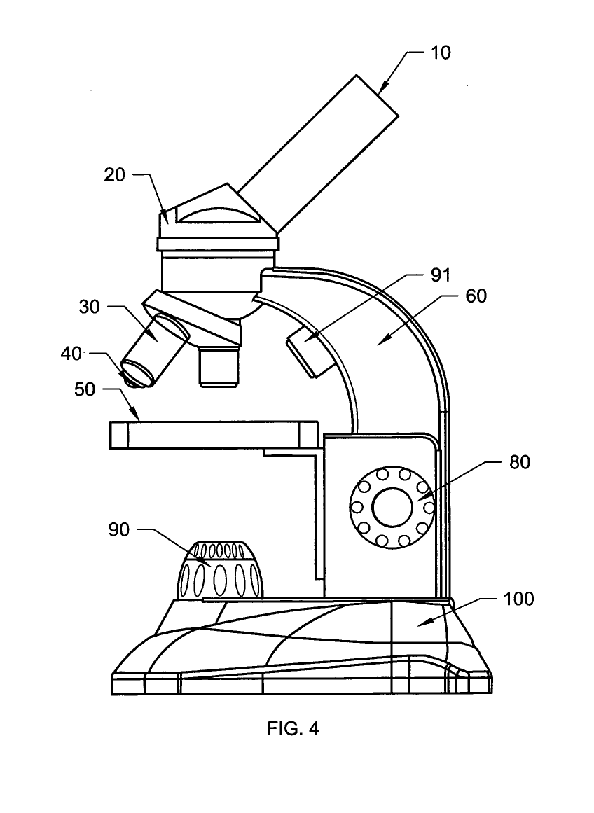

A right side view of a preferred embodiment of the present invention is illustrated in FIG. 4. A first light source 90 is clearly shown under the observation stage 50 with an observation lens of choice along the optical reflection axis. A second light source 91 formed on the inner surface of the body arm 60 projecting light on the observation objects with an angle to provide the best illumination for the best observation result. The illumination region covers entire observation stage 50.

Furthermore, both the first light source 90 and the second light source 91 shown in FIG. 4 can be made of fluorescence or LED or other suitable lights that provide best illumination for observation with the lowest manufacturing cost and energy consumption. Particularly, the illumination angle of the light sources 90 and 91 can be either fixed or adjustable to suit various research observation needs.

In addition, the second light source 91 can be formed in different spots on the microscope body arm 60 to fit different illumination needs. An adjustable light source 91 above the observation stage 50 coupled with an adjustable light source 90 under the observation stage 50 provide a multi-functional microscope that can be used as a stereo and biological microscope. Various light source materials can be chosen for manufacturing to fit different budgets and therefore significantly reduce the manufacturing cost.

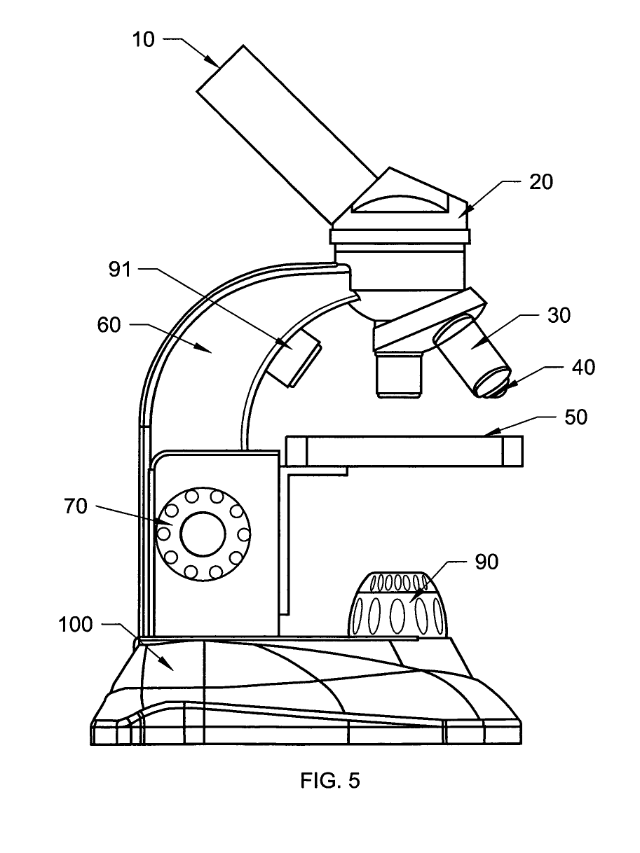

In FIG. 5, a left side view of a preferred embodiment of the present invention is illustrated. In this illustration, a first 90 and a second 91 light sources are illustrated along with adjustable knobs 70 and 80. An observation stage 50 and the annular ring-shaped member 30 holding a plurality of objective lenses 40 are also shown in FIG. 5. Various materials can be chosen during the manufacturing process to produce light weight, portable, and low cost microscopes satisfying different research needs and field study requirements.

Further, a cordless power supply can be coupled with the preferred embodiments of the present invention. A cordless power supply adds portability to the multifunctional microscopes of the present invention. A portable microscope can be relocated from lab to lab and facilitate field study more conveniently.

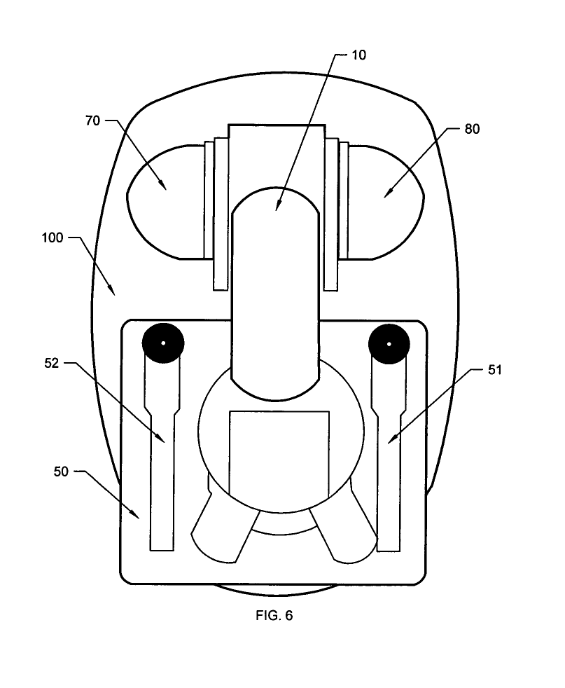

A top view of a preferred embodiment of the present invention is shown in FIG. 6. In FIG. 6, an eyepiece 10, an observation stage 50, a base 100, and two focus adjustable knobs 70 and 80 are illustrated. Further, at the observation stage 50, two clips 51 and 52 utilized to fasten a specimen between slides for observation along sides of the through hole are clearly illustrated. Specimen slides are also clearly illustrated in FIG. 6. A base 100 relatively larger than the observation stage 50 for a stable setup is also shown in this top view Figure.

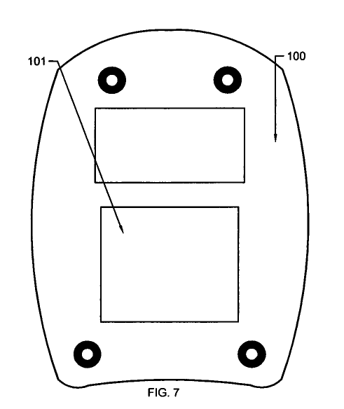

FIG. 7 shows a bottom view of a preferred embodiment of the present invention. The bottom of the semi-triangular base 100 is shown with four stable knobs underneath of it. The base 100 can be any shapes, such as rectangular or square, and any size; however, a size larger than the observation stage is reasonably expected. The base 100 can also be made of any thickness. A thickness that can position microscope stably is expected. An open 101 at the bottom of the base 100 is also shown in FIG. 7. Inside of the open 101, batteries can be used to power the microscope. Observation of objects in a remote location without electricity can be performed conveniently.

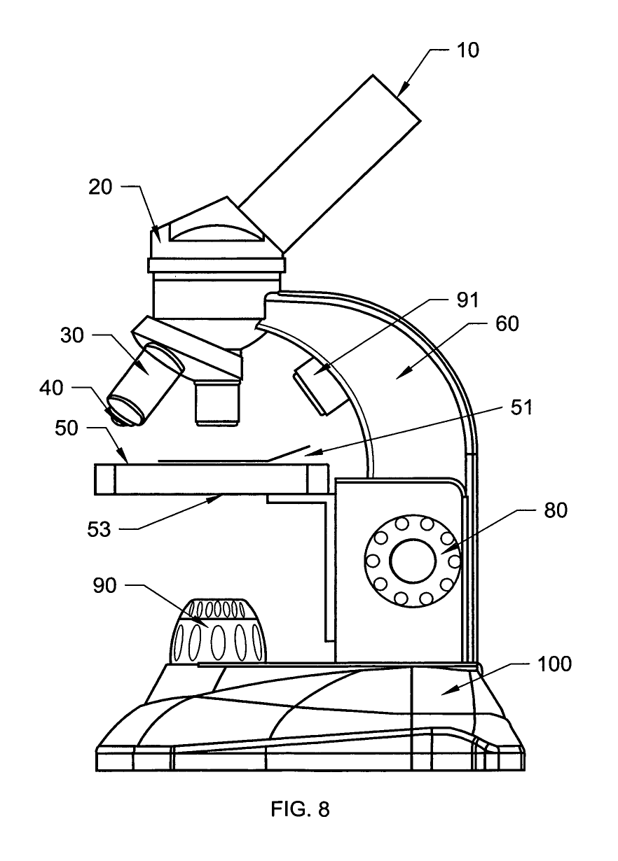

A preferred embodiment of the present invention with adjustable light source 90 under the observation stage 50 is illustrated in FIG. 8. The exterior of the adjustable light 90 can be the same as a fixed light source, which is shown in FIG. 2. Clip 51 on the observation stage 50 is shown in FIG. 9 aside to the axis in alignment with the adjustable light source 90 and the through hole 53. The illumination of the adjustable light source 90 covers not only the specimen through the through hole 53, but the entire observation stage 50. By the usage of an adjustable light source 90, better research results can be reached.

The adjustment illumination range of the adjustable light source 90 can be adjusted up to 90 degrees from all directions. It gives the microscope an adjustable illumination region a 180 degree range. In addition to the fact that another adjustable light source 91 can be set on several different spots on the body arm 60, the illumination for the observation stage 50 is provided from all angles and all directions for absolutely a clear and thorough observation.

Another preferred embodiment of the present invention with an adjustable light source 91 above the observation stage 50 is illustrated in FIG. 9. The exterior of the adjustable light 91 provided at the microscope body arm 60 is also quite similar to the exterior of a fixed light source. Clip 52 on the observation stage 50 is also shown in FIG. 9 aside to the axis in alignment with the adjustable light source 90 and the through hole 53.

The illumination of the adjustable light source 91 covers the entire observation stage 50. The adjustment illumination range of the adjustable light source 91 can be adjusted up to 90 degrees from all directions. It gives the microscope an adjustable illumination region above the observation stage 50 a 180 degree range. By the use of this adjustable light source 91, objects can be observed much better from all angles and provides much more fun for beginner users.

For a preferred embodiment of the present invention, the microscope illumination adjustment range can be from 0 to 45 degrees under the observation stage 50 and 0 to 90 degrees above the observation stage 50 in all directions. Vise versa, the microscope illumination adjustment range can also be 0 to 90 degrees under the observation stage 50 and 0 to 45 degrees above the observation stage 50 in all directions. Various adjustable angles can be configured to meet the observation needs.

The description of the present invention has been presented for purposes of illustration and description, but is not intended to be exhaustive or limited to the present invention in the form disclosed. Modifications and variations will be apparent to those skilled in the art without departing from the scope and spirit of the invention. The preferred embodiments were chosen and described in order to best explain the principles of the present invention and the practical applications, and best understand the present invention for various embodiments with various modifications as are suited to the particular use contemplated.

We claim:

1. A multifunctional microscope comprises:
an observation stage perpendicularly extended from a body arm;
a removable eyepiece installed at the upper end of the body arm with various magnifying powers; and
a plurality of light sources with adjustable angles.

2. The multifunctional microscope as claimed in claim 1, wherein one of the plurality of light sources with adjustable angles is provided under the observation stage.

3. The multifunctional microscope as claimed in claim 2, wherein the light source under the observation stage is made of LED.

4. The multifunctional microscope as claimed in claim 2, wherein the light source under the observation stage is made of Fluorescent.

5. The multifunctional microscope as claimed in claim 1, wherein one of the plurality of light sources with adjustable angles is provided at the body arm.

6. The multifunctional microscope as claimed in claim 5, wherein the light source provided at the body arm is made of LED.

7. The multifunctional microscope as claimed in claim 5, wherein the light source provided at the body arm is made of Fluorescent.

8. The multifunctional microscope as claimed in claim 1, wherein the removable eyepiece having a magnifying power of 10×.

9. The multifunctional microscope as claimed in claim 1, wherein one of the plurality of light sources has an adjustable angle from 0 to 45 degrees.

10. The multifunctional microscope as claimed in claim 1, wherein one of the plurality of light sources has an adjustable angle from 45 to 90 degrees.

11. The multifunctional microscope as claimed in claim 1, wherein the adjustable angles of the plurality of light sources can be fixed.

12. The multifunctional microscope as claimed in claim 1, wherein the adjustable angles of one of the plurality of light sources can be fixed.

13. The multifunctional microscope as claimed in claim 1 further comprises objective lenses of 4×, 10×, and 40×.

14. The multifunctional microscope as claimed in claim 1 further comprises objective lenses of 400×, and 500×.

15. The multifunctional microscope as claimed in claim 14, wherein the cordless power supply is battery.

16. The multifunctional microscope as claimed in claim 14, wherein the cordless power supply is rechargeable battery.

17. The multifunctional microscope as claimed in claim 1 further comprises a cordless power supply.

18. The multifunctional microscope as claimed in claim 1 further comprises a base connected to the lower end of the body arm, wherein the body arm can be various shapes, such as triangular, rectangular, or bilateral.

19. A multifunctional microscope comprises:
an observation stage perpendicularly extended from a body arm;
a removable eyepiece installed at the upper end of the body arm with various magnifying powers; and
a plurality of light sources with adjustable angles, wherein one of the plurality of light sources with adjustable angles is provided under the observation stage and made of LED.

20. A multifunctional microscope comprises:
an observation stage perpendicularly extended from a body arm;
a removable eyepiece installed at the upper end of the body arm with various magnifying powers; and
a plurality of light sources with adjustable angles, wherein one of the plurality of light sources with adjustable angles is provided under the observation stage with an adjustable angle from 45 to 90 degrees.
